(19) United States
(12) Patent Application Publication
(10) Pub. No.: US 2022/0034102 A1
(43) Pub. Date: Feb. 3, 2022

(54) ADJUSTABLE KNOCKDOWN TOOL

(71) Applicant: Ryan Edward Talbacka, Bismarck, ND (US)

(72) Inventor: Ryan Edward Talbacka, Bismarck, ND (US)

(21) Appl. No.: 16/942,978

(22) Filed: Jul. 30, 2020

(51) Int. Cl. E04F 21/165; B25G 1/06

(52) U.S. Cl. CPC E04F 21/1652; B25G 1/06

(57) ABSTRACT

An adjustable knockdown tool includes a coupling member, a blade support, and an actuator. The coupling member includes a housing defining a channel. The housing includes an actuator receptacle and a locking element that is located between the actuator receptacle and the channel. The locking element is movable between locking and releasing positions. The blade support extends through the channel and is coupled to a blade member. The blade support is rotatable relative to the channel when the locking element is at the releasing position so as to change an angle of the blade member, and the blade support is fixed relative to the channel when the locking element is at the locking position so as to fix the angle of the blade member. The actuator is configured to be coupled to the actuator receptacle to cause the locking element to move from the releasing to the locking position.

### TECHNICAL FIELD

This disclosure relates generally to an adjustable knockdown tool and related methods of making such a tool and using such a tool. Adjustable knockdown tool embodiments disclosed herein can include one or more features that allow an angle of a blade member of the adjustable knockdown tool to be changed relative to one or more other portions of the adjustable knockdown tool.

### BACKGROUND

A knockdown tool, such as a knockdown knife, can be used to provide an aesthetically pleasing surface finish. For example, a knockdown tool can be used to flatten texture patterns by erasing trowel lines. This is often done on wall and ceiling surfaces (e.g., drywall) as a finishing step after installation and prior to curing.

However, current knockdown tools can be difficult to effectively utilize at different surfaces. For example, a knockdown tool that is suited for texture finishing at a wall surface may be difficult to utilize at a ceiling surface. Likewise, a knockdown tool that is suited for texture finishing at a ceiling surface may be difficult to utilize at a wall surface.

### SUMMARY

This disclosure, in general, describes embodiments relating to adjustable knockdown tools as well as related methods of making and using such tools. Such adjustable knockdown tool embodiments can include one or more features that allow an angle of a blade member of the adjustable knockdown tool to be changed relative to one or more other portions of the adjustable knockdown tool. Accordingly, an adjustable knockdown tool embodiment within the scope of the present disclosure can be adjusted to orient the blade member in a manner suited for a particular surface at which the adjustable knockdown tool is to be utilized. This can allow the adjustable knockdown tool embodiments within the scope of the present disclosure to be efficiently utilized at different types of surfaces by adjusting the angle of the blade member to be suited for use at each of these different surfaces.

For example, because wall and ceiling surfaces are generally located at different elevations, changing the angle of the blade member of the adjustable knockdown tool within the scope of the present disclosure can configure the adjustable knockdown tool to be efficiently used at these different elevation surfaces. On the other hand, because traditional knockdown tools lack the ability to adjust the angle of the blade member, using a traditional knockdown tool, configured for wall surface use, at a higher elevation ceiling surface can require that a very long length handle be used and that a user stand very far away from the traditional tool in order to compensate for the fixed angle of this knockdown tool's blade. This can result in a labor-intensive and inefficient finishing process. The ability of the adjustable knockdown tool within the scope of the present disclosure to orient the blade member at different angles can facilitate a more precise and efficient finishing process across different surfaces (e.g., wall and ceiling surfaces at different elevations).

One embodiment includes an adjustable knockdown tool. This adjustable knockdown tool embodiment includes a coupling member, a blade support, and an actuator. The coupling member includes a housing. The housing defines a channel extending through the housing between a first channel aperture defined at the housing and a second channel aperture defined at the housing. The housing further includes an actuator receptacle and a locking element. The locking element is located between the actuator receptacle and the channel. The locking element is movable between a locking position at which the locking element extends into the channel and a releasing position at which the locking element retracts away from the channel toward the actuator receptacle. The blade support extends through the channel. The blade support is coupled to a blade member that extends out from the blade support. The blade support is rotatable relative to the channel when the locking element is at the releasing position so as to change an angle of the blade member relative to the housing. The blade support is fixed relative to the channel when the locking element is at the locking position so as to fix the angle of the blade member relative to the housing. The actuator is configured to be coupled to the actuator receptacle. Coupling the actuator to the actuator receptacle causes the locking element to move from the releasing position to the locking position so as to fix the angle of the blade member relative to the housing.

In a further embodiment of the above adjustable knockdown tool, decoupling the actuator from the actuator receptacle causes the locking element to move from the locking position to the releasing position so as to allow the blade support to be rotated relative to the channel to change the angle of the blade member relative to the housing.

In one embodiment of the above adjustable knockdown tool, the actuator includes a handle of the adjustable knockdown tool. A first end portion of the handle can be configured to be coupled to the actuator receptacle to cause the locking element to move from the releasing position to the locking position so as to fix the angle of the blade member relative to the housing. In such an embodiment, relative rotation, between the first end portion of the handle and the actuator receptacle, in a first direction can cause the locking element to move from the releasing position to the locking position so as to fix the angle of the blade member relative to the housing. And, relative rotation, between the first end portion of the handle and the actuator receptacle, in a second direction, opposite the first direction, can cause the locking element to move from the locking position to the releasing position so as to allow the blade support to be rotated relative to the channel to change the angle of the blade member relative to the housing.

In another embodiment of the above knockdown tool, the actuator includes an adaptor that has an adaptor body. The adaptor body can define a body first end portion and a body second end portion opposite the body first end portion. The body first end portion can be configured to be coupled to the actuator receptacle to cause the locking element to move from the releasing position to the locking position so as to fix the angle of the blade member relative to the housing. The body second end portion can be configured to be coupled to a handle of an attachment tool. In such an embodiment, the body first end portion can include a first coupling mechanism configured to be coupled to the actuator receptacle. The body second end portion can include a second coupling mechanism different than the first coupling mechanism. Relative rotation between the adaptor and the actuator receptacle can be the same as that in embodiments where the handle of the adjustable knockdown tool is the actuator.

Another adjustable knockdown tool embodiment includes a coupling member, a blade support, and an actuator. The coupling member includes a housing. The housing includes an actuator receptacle and a locking element. The locking element is movable between a locking position and a releasing position. The blade support is coupled to the coupling member. The blade support carries a blade member that extends out from the blade support. The blade support is rotatable relative to the housing when the locking element is at the releasing position so as to change an angle of the blade member relative to the housing. The blade support is fixed relative to the housing when the locking element is at the locking position so as to fix the angle of the blade member relative to the housing. The actuator is configured to be coupled to the actuator receptacle. Coupling the actuator to the actuator receptacle causes the locking element to move from the releasing position to the locking position so as to fix the angle of the blade member relative to the housing. Decoupling the actuator from the actuator receptacle causes the locking element to move from the locking position to the releasing position so as to allow the blade support to be rotated relative to the channel to change the angle of the blade member relative to the housing.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and, therefore, do not limit the scope of the invention. The drawings are not necessarily to scale and are intended for use in conjunction with the explanations in the following detailed description. Examples of the present invention will hereinafter be described in conjunction with the appended drawings.

FIG. 1 is a front elevational view of an embodiment of an adjustable knockdown tool.

FIG. 2 is a side elevational view of the adjustable knockdown tool of FIG. 1 with the blade member at a first angle relative to the housing of the coupling member of the adjustable knockdown tool.

FIG. 3 is a side elevational view of the adjustable knockdown tool of FIG. 1 with the blade member at a second angle relative to the housing of the coupling member of the adjustable knockdown tool.

FIG. 4 is a top plan view of the coupling member, of the adjustable knockdown tool of FIG. 1, showing the actuator receptacle and the locking element.

FIG. 5 is a side elevational view of the coupling member, of the adjustable knockdown tool of FIG. 1, with the locking element at a releasing position.

FIG. 6 is a side elevational view of the coupling member, of the adjustable knockdown tool of FIG. 1, with the locking element at a locking position.

FIG. 7 is an exploded, top plan view showing an embodiment of an adaptor that is configured to serve as the actuator of the adjustable knockdown tool.

FIG. 8 is a top plan view of the adaptor, of FIG. 7, coupled to the actuator receptacle to cause the locking element to move from the releasing position to the locking position.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

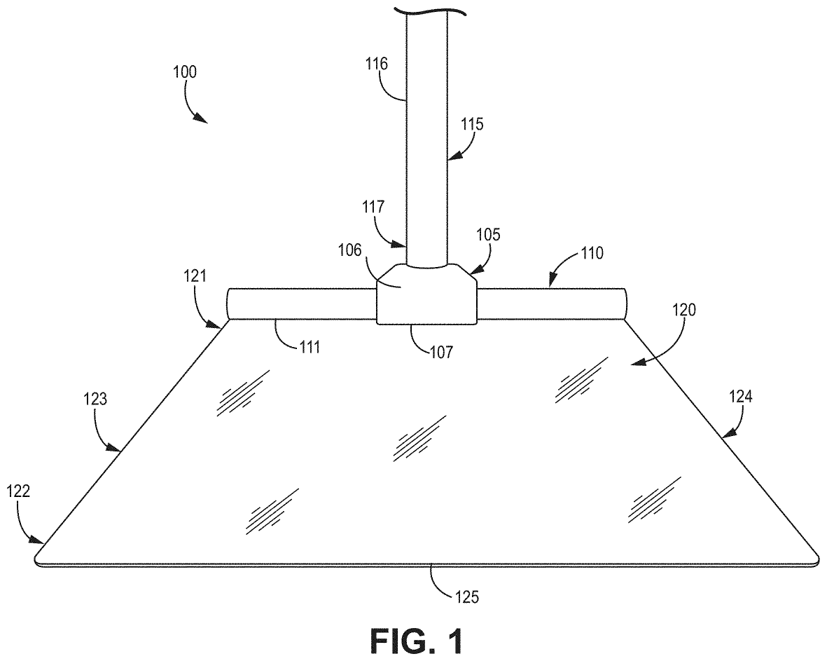

FIG. 1 illustrates a front elevational view of an embodiment of an adjustable knockdown tool 100. The adjustable knockdown tool 100 includes a coupling member 105, a blade support 110, and an actuator 115. The coupling member 105 include a housing 106. The blade support 110 and the actuator 115 can be movably coupled to the coupling member 105 at the housing 106. In the illustrated embodiment of FIG. 1, the actuator 115 includes a handle 116 of the adjustable knockdown tool 100. A first end portion 117 of the handle 116 can be configured to be removably coupled to the coupling member 105 at the housing 106.

The blade support 110 is coupled to a blade member 120 that extends out from the blade support 110. The blade support 110 defines a first blade coupling portion 111 that couples the blade member 120 to the blade support 110. In addition, in some examples, for additional support, the housing 106 can define a second blade coupling portion 107 that couples the blade member 120 to the housing 106 of the coupling member 105. As shown in the example of FIG. 1, the second blade coupling portion 107 is offset from the first blade coupling portion 111. In particular, in the illustrated embodiment, the second blade coupling portion 107 extends out in a direction toward the blade member 120 further than the first blade coupling portion 111.

The blade member 120 can include a first blade end portion 121 and a second blade end portion 122 that is opposite the first blade end portion 121. In various embodiments, the second blade end portion 122 can define a planar surface 125. In the illustrated embodiment, the second blade end portion 122 is longer than the first blade end portion 121. As shown, the first blade end portion 121 is generally coextensive in length with the blade support 110, while the second blade end portion 122 extends out beyond the ends of the blade support 110 and the first blade end portion 121. For instance, the blade member 120 can define a first side 123 and a second side 124 that is opposite the first side 123 of the blade member 120, and the second blade end portion 122 can extend between the first side 123 and the second side 124. As shown in FIG. 1, the second blade end portion 122 can extend beyond the blade support 110 at each of the first side 123 of the blade member 120 and the second side 124 of the blade member 120. And, the planar surface 125 can extend linearly between the first side 123 and the second side 124.

The first blade end portion 121 can be coupled to the blade support 110, for instance at the first blade coupling portion 111. And, in examples where the housing 106 defines the second blade coupling portion 107, the first blade end portion 121 can also be coupled to the second blade coupling portion 107. In such examples, the first blade end portion 121 can define an end surface of the blade member 120 that corresponds to the offset configuration of the first blade coupling portion 111 and the second blade coupling portion 107. Accordingly, the blade member 120 can have a recessed portion along the end surface at the first blade end portion 121 at a location corresponding to the second blade coupling portion 107.

As will be described further herein, the actuator 115 can be used to facilitate adjustment of the angle of the blade member 120. In particular, when the actuator 115 is decoupled from the housing 106 of the coupling member 105, the blade support 110 can be moved (e.g., rotated) relative to the housing 106 to change the angle of the blade member 120 relative to the housing 106. And, when the actuator 115 is coupled to the housing 106 of the coupling member 105, the blade support 110 can be fixed relative to the housing 106 to fix the angle of the blade member 120 relative to the housing 106.

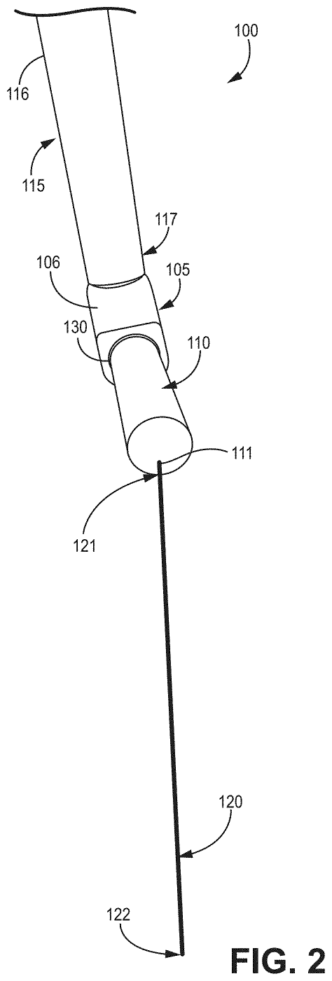

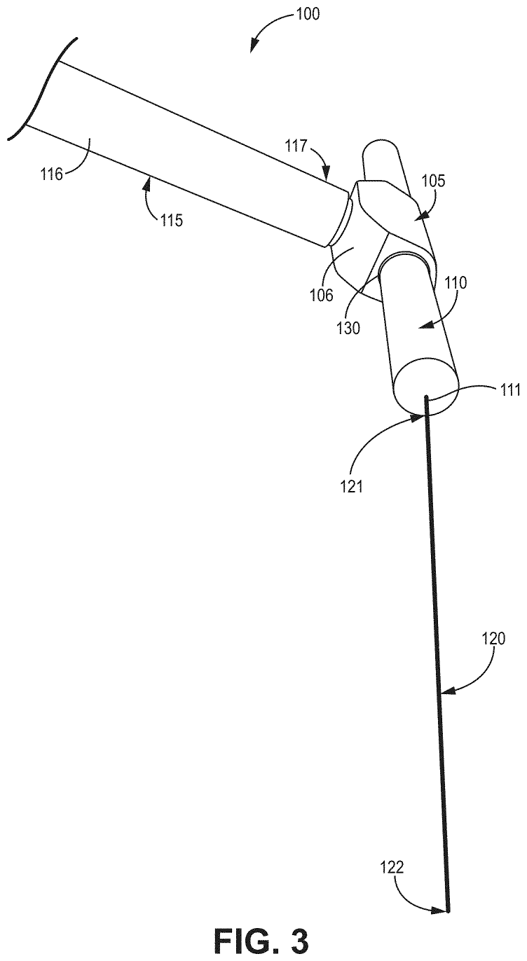

FIGS. 2 and 3 show side elevational views of the adjustable knockdown tool 100. FIG. 2 shows the blade member 120 at a first angle relative to the housing 106 of the coupling member 105. FIG. 3 shows the blade member 120 at a second, different angle relative to the housing 106 of the coupling member 105.

When the actuator 115 is decoupled from the housing 106, the blade support 110 can be rotated relative to the housing 106 to change the angle of the blade member 120 relative to the housing 106. For instance, when the actuator 115 is decoupled from the housing 106, the blade support 110 can be rotated relative to the housing 106 to change the angle of the blade member 120, relative to the housing 106, from the first angle shown in FIG. 2 to the second angle shown in FIG. 3. Then, when the blade member is oriented at a desired angle relative to the housing 106, the actuator 115 can be coupled to the housing 106 to fix the blade support 110 relative to the housing 106 and, thereby, to fix the angle of the blade member 120 relative to the housing 106. In this way, the adjustable knockdown tool 100 can facilitate a wide range of blade member 120 orientations and, as a result, facilitate efficient use of the adjustable knockdown tool 100 at a variety of different surfaces, such as wall and ceiling surfaces at differing elevations.

In the illustrated embodiment, the housing 106 defines a channel 130. The blade support 110 can extend through the channel 130. The blade support 110 can be rotatable relative to the channel 130 so as to change the angle of the blade member 120 relative to the housing 106. For example, when the actuator 115 is decoupled from the housing 106, the blade support 110 can freely rotate relative to the channel 130 to allow the angle of the blade member 120 to be oriented relative to the housing 106 as desired for a particular application of the adjustable knockdown tool 100. This could include rotating the blade support 110 from the first angle of the blade member 120 relative to the housing 106, shown in FIG. 2, to the second angle of the blade member 120 relative to the housing 106, shown in FIG. 3. Then, when the actuator 115 is coupled to the housing 106, the blade support 110 can become fixed relative to the channel 130 so as to fix the angle of the blade member 120 relative to the housing 106 at that orientation desired to the particular application of the adjustable knockdown tool 100.

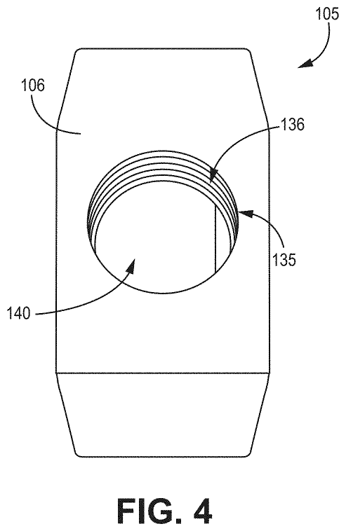

FIG. 4 shows a top plan view of the coupling member 105 of the adjustable knockdown tool 100. The housing 106 of the coupling member 105 includes an actuator receptacle 135 and a locking element 140. The locking element 140 can be movable between a locking position and a releasing position. The blade support 110 can be fixed relative to the channel 130 when the locking element 140 is at the locking position. And, the blade support 110 can be rotatable relative to the channel 130 when the locking element 140 is at the releasing position.

The actuator receptacle 135 is configured to be coupled to the actuator 115. In particular, the first end portion 117 of the handle 116 can be configured to be coupled to the actuator receptacle 135. In the illustrated embodiment, the first end portion 117 of the handle 116 can include a first threading and the actuator receptacle 135 can include a second threading 136. The first threading of the first end portion 117 of the handle 116 can be configured to be coupled to the second threading 136 of the actuator receptacle 135. Though, in other embodiments, other suitable complementary configurations at each of the first end portion 117 of the handle 116 and the actuator receptacle 135 can be used.

Coupling the actuator 115 to the actuator receptacle 135 can cause the locking element 140 to move from the releasing position to the locking position so as to fix the angle of the blade member 120 relative to the housing 106. For example, in the illustrated embodiment of the adjustable knockdown tool 100, coupling the first end portion 117 of the handle 116 to the actuator receptacle 135 can cause the locking element 140 to move from the releasing position to the locking position so as to fix the angle of the blade member 120 relative to the housing 106. Likewise, in the illustrated embodiment of the adjustable knockdown tool 100, decoupling the first end portion 117 of the handle 116 from the actuator receptacle 135 can cause the locking element 140 to move from the locking position to the releasing position so as to allow the the angle of the blade member 120 to be changed relative to the housing 106.

In this embodiment, the first end portion 117 of the handle 116 can be coupled to, and decoupled from, the actuator receptacle 135 via relative rotation between the first end portion 117 of the handle 116 and the actuator receptacle 135. For example, relative rotation in a first direction between the first end portion 117 of the handle 116 and the actuator receptacle 135 can cause the locking element 140 to move from the releasing position to the locking position so as to fix the angle of the blade member 120 relative to the housing 106. And, in this example, relative rotation in a second direction, opposite the first direction, between the first end portion 117 of the handle 116 and the actuator receptacle 135 can cause the locking element 140 to move from the locking position to the releasing position so as to allow the blade support 110 to be rotated relative to the channel 130 to change the angle of the blade member 120 relative to the housing 106. In other embodiments within the scope of the present disclosure, other relative movement(s) between the first end portion 117 of the handle 116 and the actuator receptacle 135 can couple and decouple the first end portion 117 and the actuator receptacle 135 so as to fix and adjust, respectively, the orientation of the blade member 120.

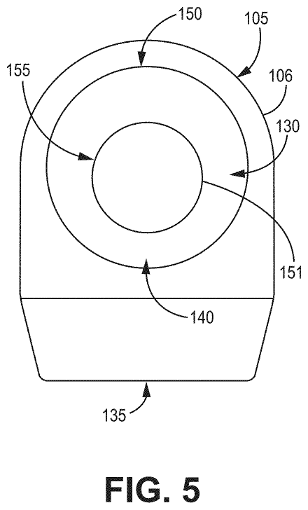

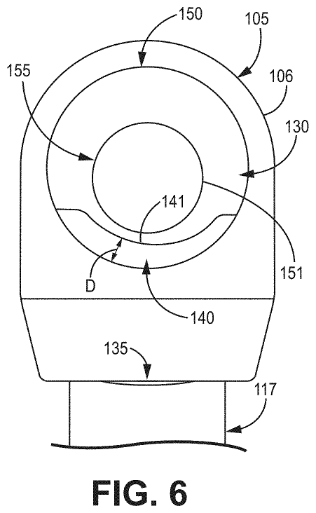

FIGS. 5 and 6 show side elevational views of the coupling member 105 of the adjustable knockdown tool 100. FIG. 5 shows the locking element 140 at the releasing position. FIG. 6 shows the locking element 140 at the locking position.

As seen in FIGS. 5 and 6, the housing 106 defines a first channel aperture 150 and a second channel aperture 155. In the illustrated embodiment, the first channel aperture 150 and the second channel aperture 155 are located at opposite sides of the housing 106. The channel 130 extends through the housing 106 between the first channel aperture 150 and the second channel aperture 155. The blade support 110 can be received at the channel 130 and extend through the channel 130 and, for instance, extend out from each of the first channel aperture 150 and the second channel aperture 155.

The locking element 140 is located between the actuator receptacle 135 and the channel 130. The locking element 140 can be movable between the locking position, at which the locking element 140 extends into the channel 130, and the releasing position, at which the locking element 140 retracts away from the channel 130 toward the actuator receptacle 135. FIG. 5 shows the coupling member 105 without the actuator 115 coupled to the actuator receptacle 135 and, thus, the locking member 140 at the releasing position. FIG. 6 shows the coupling member 105 with the first end portion 117 of the actuator 115 coupled to the actuator receptacle 135 and, thus, the locking member 140 at the locking position.

As noted, FIG. 5 shows the locking element 140 at the releasing position. In the exemplary releasing position seen in FIG. 5, the locking element 140 is retracted into the actuator receptacle 135 and no longer present within the channel 130. In the releasing position, the locking element 140 does not impede rotation of the blade support 110 at the channel 130. Thus, in the releasing position, the locking element 140 is retracted away from the channel 130 to an extent that allows the blade support 110 to be rotatable within the channel 130. In some cases, in the releasing position, the locking element 140 can be generally flush with a wall 151 of the housing 106 defining the channel 130, such that the cross-sectional diameter of the channel 130 is generally constant at locations within the channel where both the locking element 140 and the wall 151 of the housing 106 defining the channel 130 are located. Accordingly, when the locking element 140 is in the releasing position, the blade support 110 is rotatable relative to the channel 130 so as to change the angle of the blade member 120 relative to the housing 106.

The locking element 140 can be at the releasing position when the actuator 115 is decoupled from the actuator receptacle 135. For example, decoupling the actuator 115 from the actuator receptacle 135 can cause the locking element 140 to move from the locking position to the releasing position so as to allow the blade support 110 to be rotated relative to the channel 130 to change the angle of the blade member 120 relative to the housing 106. Thus, as the actuator 115 is decoupled from the actuator receptacle 135, the locking element 140 can be retracted so as to no longer extend into the channel 130.

As noted, FIG. 6 shows the locking element 140 at the locking position. In the exemplary locking position seen in FIG. 6, the locking element 140 can extend into the channel 130. As shown here, the locking element 140 extends into the channel 130 a distance D. As such, when the locking element 140 is in the locking position, the cross-sectional diameter of the channel 130 can vary such that locations within the channel 130 where the locking element 140 is present can have a smaller cross-sectional diameter. In the locking position, the locking element 140 can extend out into the channel 130 to an extent that impedes rotation of the blade support 110 at the channel 130. Accordingly, when the locking element 140 is in the locking position, the blade support 110 can be fixed relative to the channel 130 so as to fix the angle of the blade member 120 relative to the housing 106.

The locking element 140 can be at the locking position when the actuator 115 is coupled to the actuator receptacle 135. For example, coupling the actuator 115 to the actuator receptacle 135 can cause the locking element 140 to move from the releasing position to the locking position so as to fix the blade support 110 at the channel 130 to thereby fix the angle of the blade member 120 relative to the housing 106. Thus, as the actuator 115 is coupled to the actuator receptacle 135, the locking element 140 can be extended into the channel 130 such that the locking element 140 contacts the blade support 110.

In some embodiments, the locking element 140 can be freely movable between the releasing position and the locking position. In such embodiments, force imparted on the locking element upon contact with the actuator 115 being coupled to the actuator receptacle 135 can cause the locking element 140 to move to the locking position and be maintained at the locking position by contact with the actuator 115. In other embodiments, a biasing element can be included at the coupling member 105 and configured to impart a biasing force on the locking element 140 that biases the locking element 140 to one of the locking and releasing positions such that coupling or decoupling the actuator 115 at the coupling member 105 overcomes this biasing force and moves the locking element 140 to the other of the locking and releasing positions.

As seen in FIG. 6, the locking element 140 can include an inner surface 141 facing the channel 130. The inner surface 141 of the locking element 140 can be configured to contact the blade support 110 when it is located within the channel 130. For example, the inner surface 141 of the locking element 140 can define a curved surface, for instance corresponding to curvature at an exterior surface of the blade support 110 that is to be received at the channel 130. Also, when the inner surface 141 of the locking element 140 defines a curved surface, the curved inner surface 141 of the locking element 140 can match a curvature of the wall 151 of the housing 106 defining the channel 130.

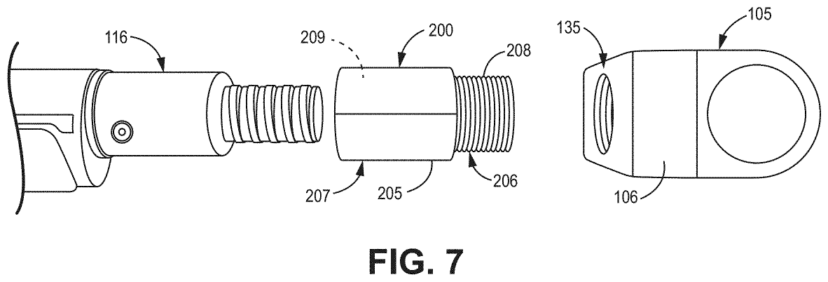

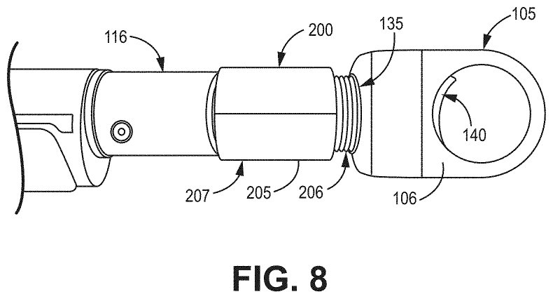

FIGS. 7 and 8 show an embodiment of an adaptor 200 that is configured to serve as the actuator 115 of the adjustable knockdown tool 100. FIG. 7 is an exploded, top plan view showing the adaptor 200, and FIG. 8 is a top plan view of the adaptor 200 coupled to the actuator receptacle 135 to cause the locking element 140 to move from the releasing position to the locking position.

As noted, in the example shown in FIGS. 7 and 8, the actuator 115 includes the adaptor 200. The adaptor 200 includes an adaptor body 205. The adaptor body 205 defines a body first end portion 206 and a body second end portion 207 that is opposite the body first end portion 206. The body first end portion 206 is configured to be coupled to the actuator receptacle 135 to cause the locking element 140 to move from the releasing position to the locking position so as to fix the angle of the blade member 120 relative to the housing 106. As such, the first body end portion 206 can include a first coupling mechanism 208 that is configured to be coupled to the actuator receptacle 135. For instance, in embodiments where the actuator receptacle 135 includes the second threading described previously, the first body end portion 206 can include the first threading complementary to the second threading, similar to the first end portion 117 described previously. The body second end portion 207 is configured to be coupled to the handle 116 of an attachment tool. The second body end portion 207 can include a second coupling mechanism 209 that is configured to be coupled to the handle 116 of the attachment tool. The second coupling mechanism 209 can be a different coupling mechanism than the first coupling mechanism 208. For instance, in the illustrated embodiment, the first coupling mechanism 208 is a male threaded mechanism, while the second coupling mechanism 209 is a female threaded mechanism. In this way, the different first and second coupling mechanisms 208, 209 can facilitate coupling of the adaptor to two different elements. This can allow, for instance, various different types of tools to be used with the coupling member 105 and associated blade support 110 and blade member 120.

The adaptor 200 can serve as the actuator 115. As such, coupling the adaptor 200 to the actuator receptacle 135 can move the locking element 140 to the locking position. Likewise, decoupling the adaptor 200 from the actuator receptacle 135 can move the locking element 140 from the locking position to the releasing position. For example, the first coupling mechanism 208 can be coupled to, and decoupled from, the actuator receptacle 135 via relative rotation as described previously in reference to the first end portion 117 of the handle 116.

Various examples have been described. These and other examples are within the scope of the following claims.

What is claimed is:

1. An adjustable knockdown tool comprising:
a coupling member including a housing, the housing defining a channel extending through the housing between a first channel aperture defined at the housing and a second channel aperture defined at the housing, the housing further including an actuator receptacle and a locking element, the locking element located between the actuator receptacle and the channel, the locking element being movable between a locking position at which the locking element extends into the channel and a releasing position at which the locking element retracts away from the channel toward the actuator receptacle;
a blade support extending through the channel, the blade support coupled to a blade member that extends out from the blade support, the blade support being rotatable relative to the channel when the locking element is at the releasing position so as to change an angle of the blade member relative to the housing, and the blade support being fixed relative to the channel when the locking element is at the locking position so as to fix the angle of the blade member relative to the housing; and
an actuator configured to be coupled to the actuator receptacle, wherein coupling the actuator to the actuator receptacle causes the locking element to move from the releasing position to the locking position so as to fix the angle of the blade member relative to the housing.

2. The tool of claim 1, wherein decoupling the actuator from the actuator receptacle causes the locking element to move from the locking position to the releasing position so as to allow the blade support to be rotated relative to the channel to change the angle of the blade member relative to the housing.

3. The tool of claim 1, wherein the locking element includes an inner surface facing the channel, and wherein the inner surface of the locking element is a curved surface.

4. The tool of claim 3, wherein the curved surface of the locking element matches a curvature of a wall of the housing defining the channel.

5. The tool of claim 1, wherein when the locking element is at the releasing position the locking element is retracted into the actuator receptacle and no longer present within the channel.

6. The tool of claim 1, wherein the actuator comprises a handle of the adjustable knockdown tool, and wherein a first end portion of the handle is configured to be coupled to the actuator receptacle to cause the locking element to move from the releasing position to the locking position so as to fix the angle of the blade member relative to the housing.

7. The tool of claim 6, wherein the first end portion of the handle comprises a first threading and the actuator receptacle comprises a second threading, and wherein the first threading of the first end portion of the handle is configured to be coupled to the second threading of the actuator receptacle.

8. The tool of claim 6, wherein relative rotation, between the first end portion of the handle and the actuator receptacle, in a first direction causes the locking element to move from the releasing position to the locking position so as to fix the angle of the blade member relative to the housing, and wherein relative rotation, between the first end portion of the handle and the actuator receptacle, in a second direction, opposite the first direction, causes the locking element to move from the locking position to the releasing position so as to allow the blade support to be rotated relative to the channel to change the angle of the blade member relative to the housing.

9. The tool of claim 1, wherein the actuator comprises an adaptor including an adaptor body, the adaptor body defining a body first end portion and a body second end portion opposite the body first end portion, the body first end portion configured to be coupled to the actuator receptacle to cause the locking element to move from the releasing position to the locking position so as to fix the angle of the blade member relative to the housing, the body second end portion configured to be coupled to a handle of an attachment tool.

10. The tool of claim 9, wherein the body first end portion includes a first coupling mechanism configured to be coupled to the actuator receptacle, and wherein the body second end portion includes a second coupling mechanism different than the first coupling mechanism.

11. The tool of claim 1, wherein the blade support defines a first blade coupling portion that couples the blade member to the blade support.

12. The tool of claim 11, wherein the housing defines a second blade coupling portion that couples the blade member to the housing.

13. The tool of claim 12, wherein the second blade coupling portion is offset from the first blade coupling portion.

14. The tool of claim 1, wherein the blade member includes a first blade end portion coupled to the blade support and a second blade end portion that is opposite the first blade end portion, the second blade end portion being longer than the first blade end portion.

15. The tool of claim 14, wherein the second blade end portion extends between a first side of the blade member and a second side of the blade member opposite the first side of the blade member, the second blade end portion extending beyond the blade support at each of the first side of the blade member and the second side of the blade member.

16. The tool of claim 15, wherein the second blade end portion defines a planar surface.

17. An adjustable knockdown tool comprising:
a coupling member including a housing, the housing including an actuator receptacle and a locking element, the locking element being movable between a locking position and a releasing position;
a blade support coupled to the coupling member, the blade support carrying a blade member that extends out from the blade support, the blade support being rotatable relative to the housing when the locking element is at the releasing position so as to change an angle of the blade member relative to the housing, and the blade support being fixed relative to the housing when the locking element is at the locking position so as to fix the angle of the blade member relative to the housing; and
an actuator configured to be coupled to the actuator receptacle, wherein coupling the actuator to the actuator receptacle causes the locking element to move from the releasing position to the locking position so as to fix the angle of the blade member relative to the housing, and wherein decoupling the actuator from the actuator receptacle causes the locking element to move from the locking position to the releasing position so as to allow the blade support to be rotated relative to the channel to change the angle of the blade member relative to the housing.

18. The tool of claim 17, wherein the locking element is located between the actuator receptacle and the blade support, wherein at the locking position the locking element is in contact with the blade support, and wherein at the releasing position the locking element is retracting away from the blade support toward the actuator receptacle.

19. The tool of claim 17, wherein the actuator comprises a handle of the adjustable knockdown tool, and wherein a first end portion of the handle is configured to be coupled to the actuator receptacle to cause the locking element to move from the releasing position to the locking position so as to fix the angle of the blade member relative to the housing.

20. The tool of claim 19, wherein relative rotation, between the first end portion of the handle and the actuator receptacle, in a first direction causes the locking element to move from the releasing position to the locking position so as to fix the angle of the blade member relative to the housing, and wherein relative rotation, between the first end portion of the handle and the actuator receptacle, in a second direction, opposite the first direction, causes the locking element to move from the locking position to the releasing position so as to allow the blade support to be rotated relative to the channel to change the angle of the blade member relative to the housing.
